(19) United States
(12) Patent Application Publication
(10) Pub. No.: US 2016/0150761 A1
(43) Pub. Date: Jun. 2, 2016

(54) APPARATUS FOR MEAT-SAUSAGE PORTION AND FOR A MEDICINAL PILL

(71) Applicant: Michael CHMIELEWSKI, St. Catharines, CA (US)

(72) Inventor: Michael CHMIELEWSKI, St. Catharines, CA (US)

(21) Appl. No.: 14/555,947

(22) Filed: Nov. 28, 2014

(51) Int. Cl. A01K 13/00; A47J 25/00; B26F 1/32

(52) U.S. Cl. CPC A01K 13/003; B26F 1/32; A47J 25/00

(57) ABSTRACT

An apparatus is for a meat-sausage portion and for a medicinal pill. The meat-sausage portion has an internal-core portion. The apparatus includes an elongated handle assembly configured for user manipulation. An elongated shaft longitudinally extends from the elongated handle assembly. The elongated shaft is configured to: (A) be insertable and extendable into the meat-sausage portion; (B) operatively receive the internal-core portion once the elongated shaft is positioned into the meat-sausage portion to do just so; (C) retain the internal-core portion of the meat-sausage portion for the case where the elongated shaft is operatively rotated; and (D) be retractable along with the internal-core portion from the meat-sausage portion along with the internal-core portion.

### TECHNICAL FIELD

Aspects generally relate to an apparatus for a meat-sausage portion having an internal-core portion and for a medicinal pill (and method thereof).

### BACKGROUND

It is known to feed a pet (such as a dog) a medicinal pill by forcing the pet to open the mouth, and popping the medicinal pill into the mouth of the pet.

### SUMMARY

It will be appreciated there exists a need to mitigate (at least in part) at least one problem associated with existing ways for feeding a medicinal pill into a pet's mouth. After much study of the known systems and methods with experimentation, an understanding of the problem and its solution has been identified and is articulated as follows:

Sometimes, a pet, such as a dog, is required to consume a medicinal pill. The problem associated with the known technique of wrapping the medicinal pill in a cheese slice and then feeding it to your pet (such as, a dog) is that this may inadvertently fatten the pet. As well, another known technique requires the user to manually insert or stick a finger down the throat of the pet in order for the pet to receive the medicinal pill.

To mitigate, at least in part, at least one problem associated with existing ways for getting a medicinal pill into a pet's mouth, there is provided (in accordance with a major aspect) an apparatus. The apparatus is for a meat-sausage portion and for a medicinal pill. The meat-sausage portion has an internal-core portion. The apparatus includes an elongated handle assembly configured for user manipulation. An elongated shaft longitudinally extends from the elongated handle assembly. The elongated shaft is configured to: (A) be insertable and extendable into the meat-sausage portion; (B) operatively receive the internal-core portion once the elongated shaft is positioned into the meat-sausage portion to do just so; (C) retain the internal-core portion of the meat-sausage portion for a case where the elongated shaft is operatively rotated; and (D) be retractable along with the internal-core portion from the meat-sausage portion along with the internal-core portion.

Other aspects are identified in the claims.

Other aspects and features of the non-limiting embodiments may now become apparent to those skilled in the art upon review of the following detailed description of the non-limiting embodiments with the accompanying drawings.

### DETAILED DESCRIPTION OF THE DRAWINGS

The non-limiting embodiments may be more fully appreciated by reference to the following detailed description of the non-limiting embodiments when taken in conjunction with the accompanying drawings, in which:

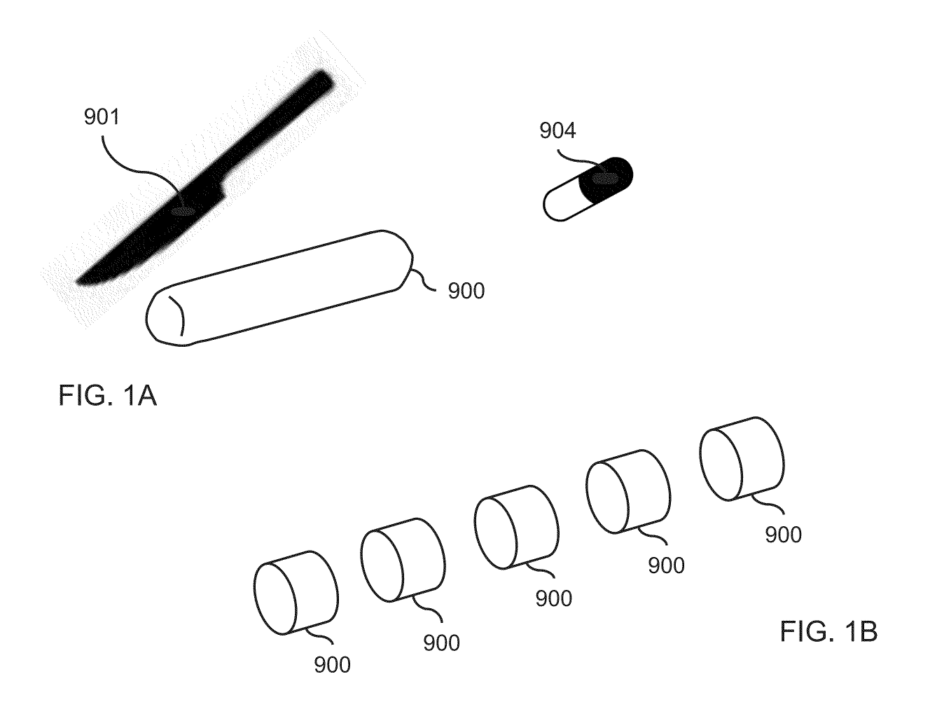

FIGS. 1A and 1B (SHEET 1 OF 5 SHEETS) depict perspective views of embodiments of a meat-sausage portion and a medicinal pill;

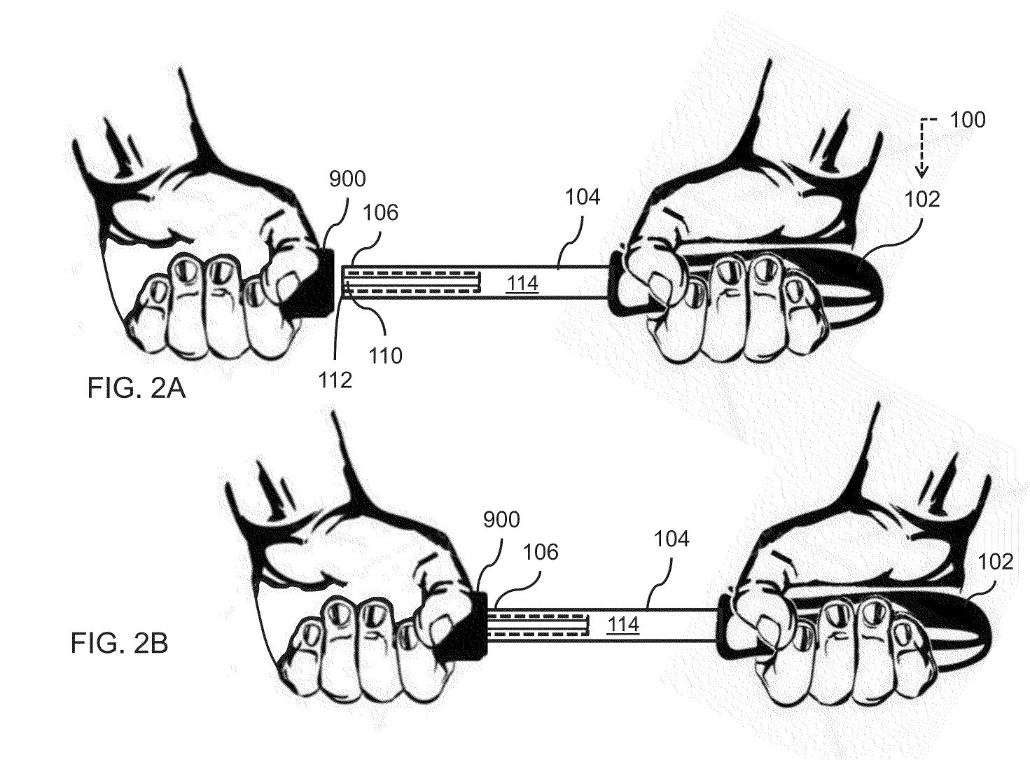

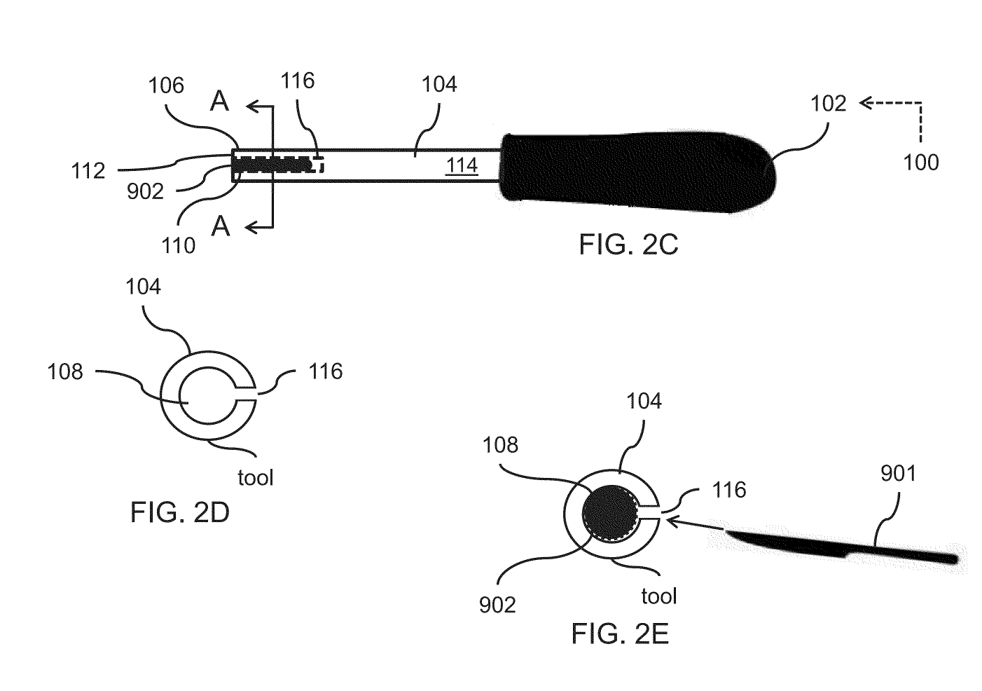

FIGS. 2A and 2B (SHEET 2 OF 5 SHEETS) depict side views of embodiments of an apparatus for the meat-sausage portion of FIGS. 1A and/or 1B;

FIGS. 2C, 2D and 2E (SHEET 3 OF 5 SHEETS) depict views of embodiments of the apparatus for the meat-sausage portion of FIGS. 1A and/or 1B;

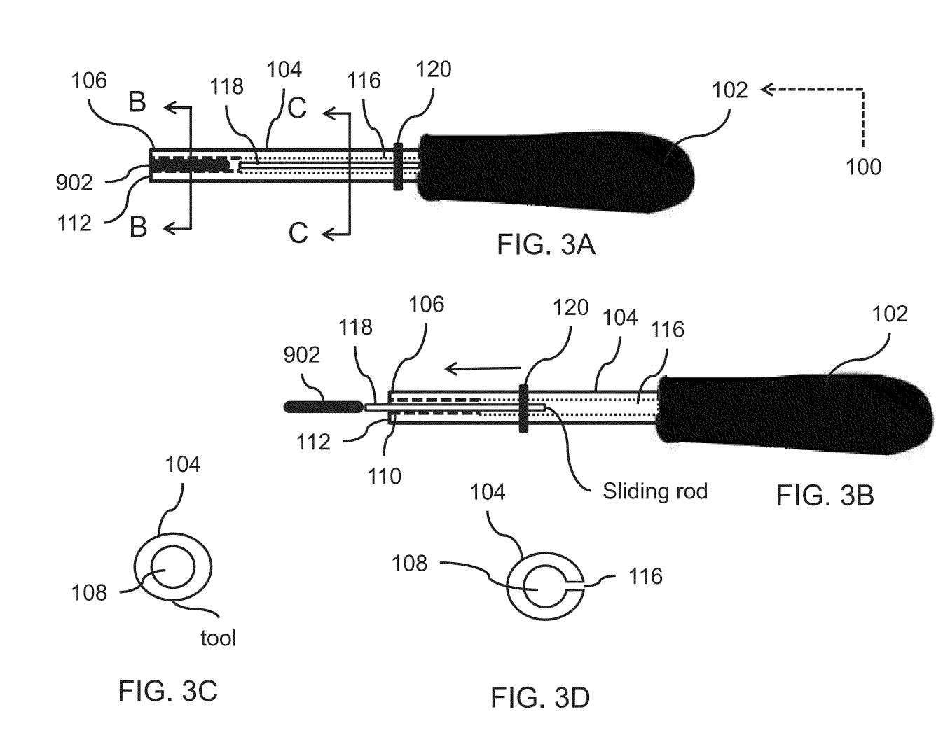

FIGS. 3A, 3B, 3C and 3D (SHEET 4 OF 5 SHEETS) depict views of embodiments of the apparatus for the meat-sausage portion of FIGS. 1A and/or 1B; and

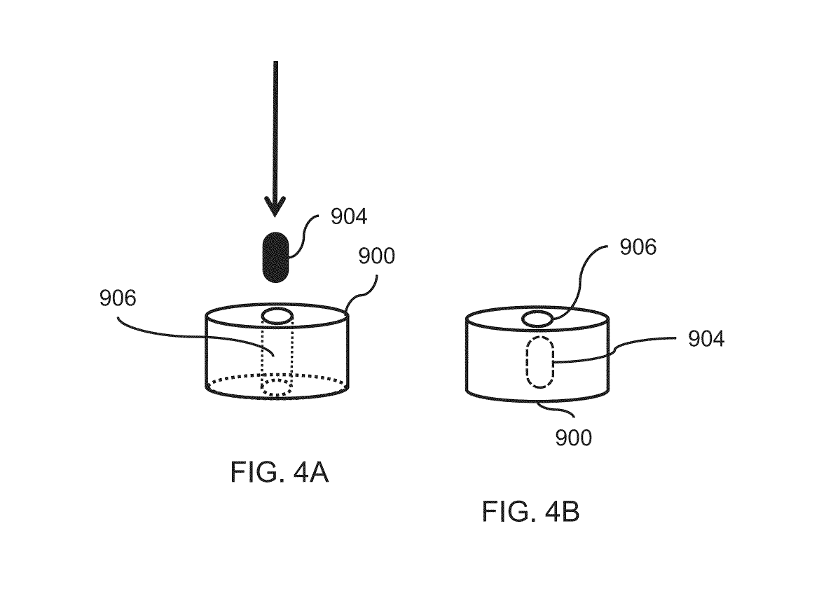

FIGS. 4A and 4B (SHEET 5 OF 5 SHEETS) depict views of embodiments of the meat-sausage portion and the medicinal pill of FIGS. 1A and/or 1B.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the Drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

100 apparatus

102 elongated handle assembly

104 elongated shaft

106 shaft end portion

108 internal shaft cavity

110 cavity entrance

112 leading circumferential meat-cutting edge

114 outer longitudinally-extending surface

116 longitudinally-extending access groove

118 plunger assembly

120 plunger extension

900 meat-sausage portion

901 knife

902 internal-core portion

904 medicinal pill

906 internal meat void

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

FIGS. 1A and 1B depict perspective views of embodiments of a meat-sausage portion 900 and a medicinal pill 904.

In accordance with the embodiment depicted in FIG. 1A, the meat-sausage portion 900 includes, for example, an entire hot dog (of any sort of meat product) or an entire meat sausage (and any equivalent thereof).

In accordance with the embodiment depicted in FIG. 1B, the meat-sausage portion 900 includes a portion of an entire hot dog or a portion of an entire meat sausage (and any equivalent thereof). A knife 901 may be used to cut an entire hot dog (if so desired).

FIGS. 2A, 2B, 2C, 2D and 2E depict views of embodiments of the apparatus 100 for the meat-sausage portion 900 of FIGS. 1A and/or 1B. FIGS. 2A and 2B and 2C depict side views. FIGS. 2D and 2E depict a cross-sectional view taken along the line A-A of FIG. 2C.

In accordance with a first embodiment depicted in FIGS. 2A, 2B and 2C, the apparatus 100 is for the meat-sausage portion 900 and is also for the medicinal pill 904. The meat-sausage portion 900 has (defines) the internal-core portion 902.

The apparatus 100 includes an elongated handle assembly 102 configured for user manipulation. The apparatus 100 also includes an elongated shaft 104 longitudinally extending from the elongated handle assembly 102.

The elongated shaft 104 is configured to be insertable and extendable into the meat-sausage portion 900. The elongated shaft 104 is also configured to operatively receive the internal-core portion 902 once the elongated shaft 104 is positioned into the meat-sausage portion 900 to do just so. The elongated shaft 104 is also configured to retain the internal-core portion 902 of the meat-sausage portion 900 for a case where the elongated shaft 104 is operatively rotated. The elongated shaft 104 is also configured to be retractable along with the internal-core portion 902 from the meat-sausage portion 900 along with the internal-core portion 902.

A technical effect of the apparatus 100 is that with the medicinal pill 904 once inserted into the meat-sausage portion 900, a pet (such as, a dog) is more easily motivated to consume the medicinal pill 904, and the apparatus 100 makes it easier for the dog to receive the medicinal pill 904 with less effort and frustration.

In accordance with a second embodiment depicted in FIGS. 2A, 2B and 2C, the elongated shaft 104 is further adapted in such a way that the elongated shaft 104 is configured to be insertable and extendable into the meat-sausage portion 900. This is done in such a way that the elongated shaft 104, once inserted, operatively cuts and separates side walls of the internal-core portion 902 from the meat-sausage portion 900 (once inserted into the meat-sausage portion 900 to do just so). The elongated shaft 104 operatively receives the internal-core portion 902 for a case where the elongated shaft 104 is operatively inserted into the meat-sausage portion 900 once the elongated shaft 104 is positioned in the meat-sausage portion 900 to do just so.

The elongated shaft 104 is further configured to retain the internal-core portion 902 of the meat-sausage portion 900 for a case where the elongated shaft 104 is operatively rotated to separate an end wall of the internal-core portion 902 from the meat-sausage portion 900.

The elongated shaft 104 is further configured to be retractable along with the internal-core portion 902 from the meat-sausage portion 900. This is done in such a way that the meat-sausage portion 900 defines an internal meat void 906. The internal meat void 906 is positioned where the internal-core portion 902 was operatively removed from the meat-sausage portion 900. The internal meat void 906 is configured to operatively insertably receive the medicinal pill 904 for the case where the internal-core portion 902 is removed from the interior of the meat-sausage portion 900 (by removal of the shaft end portion 106).

In accordance with third embodiment depicted in FIGS. 2A, 2B and 2C, the apparatus 100 is further adapted to include a shaft end portion 106 extending from the elongated shaft 104. The shaft end portion 106 defines an internal shaft cavity 108 and also defines a cavity entrance 110 leading to the internal shaft cavity 108. The internal shaft cavity 108 is configured for fluid communication with an exterior of the elongated shaft 104 for the case where the cavity entrance 110 is unblocked.

The apparatus 100 further includes a leading circumferential meat-cutting edge 112 extending from the shaft end portion 106 of the elongated shaft 104. The leading circumferential meat-cutting edge 112 surrounds, at least in part, the cavity entrance 110 leading into the internal shaft cavity 108. The leading circumferential meat-cutting edge 112 of the shaft end portion 106 is configured to be insertable and extendable into the meat-sausage portion 900. This is done in such a way that the leading circumferential meat-cutting edge 112, once inserted, operatively cuts and separates side walls of the internal-core portion 902 from the meat-sausage portion 900. The cavity entrance 110 and the internal shaft cavity 108 operatively receives the internal-core portion 902 for a case where the leading circumferential meat-cutting edge 112 is operatively inserted into the meat-sausage portion 900 (that is, once the leading circumferential meat-cutting edge 112 is positioned in the meat-sausage portion 900 to do just so).

The cavity entrance 110 and the internal shaft cavity 108 is configured to retain the internal-core portion 902 of the meat-sausage portion 900 for a case where the elongated shaft 104 and the shaft end portion 106 are operatively rotated to separate an end wall of the internal-core portion 902 from the meat-sausage portion 900.

The leading circumferential meat-cutting edge 112 of the shaft end portion 106 is retractable from the meat-sausage portion 900. This is done in such a way that the meat-sausage portion 900 defines an internal meat void 906 for the case where the shaft end portion 106 is retracted away from the meat-sausage portion 900 to do just so.

The internal meat void 906 is positioned where the internal-core portion 902 was operatively removed from the meat-sausage portion 900. The internal meat void 906 is configured to operatively insertably receive the medicinal pill 904 for the case where the internal-core portion 902 is removed from the interior of the meat-sausage portion 900 (by removal of the shaft end portion 106).

In accordance with a fourth embodiment depicted in FIGS. 2D and 2E, the apparatus 100 is further adapted in such a way that the elongated shaft 104 includes an outer longitudinally-extending surface 114. The elongated shaft 104 defines a longitudinally extending longitudinally-extending access groove 116 that extends from the shaft end portion 106 along a length of the outer longitudinally-extending surface 114. The longitudinally-extending access groove 116 radially extends between, at least in part, the internal shaft cavity 108 and the outer longitudinally-extending surface 114. The longitudinally-extending access groove 116 is configured to permit access to the internal-core portion 902 that is lodged in the internal shaft cavity 108 at the shaft end portion 106.

FIGS. 3A, 3B, 3C and 3D depict views of embodiments of the apparatus 100 for the meat-sausage portion 900 of FIGS. 1A and/or 1B. FIG. 3A and 3B depict side views. FIG. 3C depicts a cross-sectional view taken along line B-B of FIG. 3A. FIG. 3D depicts a cross-sectional view taken along line C-C of FIG. 3A.

In accordance with a fifth embodiment depicted in FIGS. 3A to 3D, the apparatus 100 is further adapted such that the apparatus 100 further includes a plunger assembly 118 operatively slidably received in the internal shaft cavity 108 of the elongated shaft 104. A plunger extension 120 extends radially from the plunger assembly 118.

The elongated shaft 104 includes an outer longitudinally-extending surface 114. The elongated shaft 104 includes an outer longitudinally-extending surface 114. The elongated shaft 104 defines a longitudinally extending longitudinally-extending access groove 116 extending between the shaft end portion 106 along a length of the outer longitudinally-extending surface 114. The longitudinally-extending access groove 116 radially extends between, at least in part, the internal shaft cavity 108 and the outer longitudinally-extending surface 114. The longitudinally-extending access groove 116 is configured to permit access to the internal-core portion 902 that is lodged in the internal shaft cavity 108 at the shaft end portion 106. The plunger extension 120 extends radially from the plunger assembly 118 through the longitudinally-extending access groove 116. Once the plunger assembly 118 is moved, the plunger assembly 118 moves the internal-core portion 902 away from the shaft end portion 106.

FIGS. 4A and 4B depict perspective views of embodiments of the meat-sausage portion 900 and the medicinal pill 904 of FIGS. 1A and/or 1B.

Referring to FIGS. 4A and 4B, the medicinal pill 904 is inserted into the internal meat void 906 defined by the meat-sausage portion 900, and the internal meat void 906 was formed by using any one of the embodiments of the apparatus 100.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly, or component that may be superior to any of the equivalents available to the person skilled in art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus for a meat-sausage portion having an internal-core portion and for a medicinal pill, the apparatus comprising:
an elongated handle assembly being configured for user manipulation; and
an elongated shaft longitudinally extending from the elongated handle assembly, and the elongated shaft being configured:
be insertable and extendable into the meat-sausage portion;
operatively receive the internal-core portion once the elongated shaft is positioned into the meat-sausage portion to do just so;
retain the internal-core portion of the meat-sausage portion for a case where the elongated shaft is operatively rotated; and
be retractable along with the internal-core portion from the meat-sausage portion along with the internal-core portion.

2. An apparatus for a meat-sausage portion having an internal-core portion and for a medicinal pill, the apparatus comprising:
an elongated handle assembly being configured for user manipulation;
an elongated shaft extending longitudinally from the elongated handle assembly, and the elongated shaft being configured to:
be insertable and extendable into the meat-sausage portion in such a way that the elongated shaft, once inserted, operatively cuts and separates side walls of the internal-core portion from the meat-sausage portion, and the elongated shaft operatively receives the internal-core portion for a case where the elongated shaft is operatively inserted into the meat-sausage portion once the elongated shaft is positioned in the meat-sausage portion to do just so;
retain the internal-core portion of the meat-sausage portion for the case where the elongated shaft is operatively rotated to separate an end wall of the internal-core portion from the meat-sausage portion; and
be retractable along with the internal-core portion from the meat-sausage portion in such a way that the meat-sausage portion defines an internal meat void being positioned where the internal-core portion was operatively removed from the meat-sausage portion, and the internal meat void being configured to operatively insertably receive the medicinal pill for the case where the internal-core portion is removed from the interior of the meat-sausage portion by removal of the elongated shaft.

3. An apparatus for a meat-sausage portion having an internal-core portion and for a medicinal pill, the apparatus comprising:
an elongated handle assembly being configured for user manipulation;
an elongated shaft longitudinally extending from the elongated handle assembly;
a shaft end portion extending from the elongated shaft;
the shaft end portion defining an internal shaft cavity and also defining a cavity entrance leading to the internal shaft cavity, and the internal shaft cavity being configured for fluid communication with an exterior of the elongated shaft for the case where the cavity entrance is unblocked;
a leading circumferential meat-cutting edge extending from the shaft end portion of the elongated shaft, and the leading circumferential meat-cutting edge surrounding, at least in part, the cavity entrance leading into the internal shaft cavity;
the leading circumferential meat-cutting edge of the shaft end portion being configured to be insertable and extendable into the meat-sausage portion in such a way that the leading circumferential meat-cutting edge, once inserted, operatively cuts and separates side walls of the internal-core portion from the meat-sausage portion, and the cavity entrance and the internal shaft cavity operatively receives the internal-core portion for the case where the leading circumferential meat-cutting edge is operatively inserted into the meat-sausage portion once the leading circumferential meat-cutting edge is positioned in the meat-sausage portion to do just so;
the cavity entrance and the internal shaft cavity being configured to retain the internal-core portion of the meat-sausage portion for the case where the elongated shaft and the shaft end portion are operatively rotated to separate an end wall of the internal-core portion from the meat-sausage portion; and
the leading circumferential meat-cutting edge of the shaft end portion is retractable from the meat-sausage portion in such a way that the meat-sausage portion defines an internal meat void for the case where the shaft end portion is retracted away from the meat-sausage portion to do just so, and the internal meat void being positioned where the internal-core portion was operatively removed from the meat-sausage portion, and the internal meat void being configured to operatively insertably receive the medicinal pill for the case where the internal-core portion is removed from the interior of the meat-sausage portion by removal of the shaft end portion.

4. The apparatus of claim 3, wherein:
the elongated shaft includes an outer longitudinally-extending surface.

5. The apparatus of claim 4, wherein:
the elongated shaft defines a longitudinally extending longitudinally-extending access groove extending from the shaft end portion along a length of the outer longitudinally-extending surface.

6. The apparatus of claim 5, wherein:
the longitudinally-extending access groove radially extending between, at least in part, the internal shaft cavity and the outer longitudinally-extending surface.

7. The apparatus of claim 6, wherein:
the longitudinally-extending access groove being configured to permit access to the internal-core portion being lodged in the internal shaft cavity at the shaft end portion.

8. The apparatus of claim 3, further comprising:
a plunger assembly being operatively slidably received in the internal shaft cavity of the elongated shaft.

9. The apparatus of claim 8, further comprising:
a plunger extension extending radially from the plunger assembly, and once the plunger assembly is moved, the plunger assembly moves the internal-core portion away from the shaft end portion.

10. The apparatus of claim 9, wherein:
the elongated shaft includes an outer longitudinally-extending surface.

11. The apparatus of claim 10, wherein:
the elongated shaft defines a longitudinally extending longitudinally-extending access groove extending between the shaft end portion along a length of the outer longitudinally-extending surface.

12. The apparatus of claim 11, wherein:
the longitudinally-extending access groove radially extending between, at least in part, the internal shaft cavity and the outer longitudinally-extending surface.

13. The apparatus of claim 12, wherein:
the longitudinally-extending access groove being configured to permit access to the internal-core portion being lodged in the internal shaft cavity at the shaft end portion.

14. The apparatus of claim 13, wherein:
the plunger extension extends radially from the plunger assembly through the longitudinally-extending access groove.
